(19) United States
(12) Patent Application Publication
(10) Pub. No.: US 2026/0150045 A1
(43) Pub. Date: May 28, 2026

(54) REFERENCE SIGNAL MEASUREMENTS USING A WAKE-UP RADIO FOR SMALL DATA TRANSMISSIONS (SDTS)

(71) Applicant: QUALCOMM Incorporated, San Diego, CA (US)

(72) Inventors: Jung Ho RYU, Englewood Cliffs, NJ (US); Tao LUO, San Diego, CA (US); Igor GUTMAN, Hod HaSharon (IL); Hemant SAGGAR, San Diego, CA (US); Jelena DAMNJANOVIC, Del Mar, CA (US); Prashant SHARMA, San Marcos, CA (US)

(21) Appl. No.: 18/959,571

(22) Filed: Nov. 25, 2024

(51) Int. Cl. H04W 52/02

(52) U.S. Cl. CPC H04W 52/0235; H04W 52/0238

(57) ABSTRACT

Methods, systems, and devices for wireless communications are described. In some systems, a user equipment (UE) may include a main radio and a low-power wake-up radio. While operating in a radio resource control (RRC) inactive state, the UE may use the low-power wake-up radio to monitor for signals. In some examples, the UE or a network entity may determine a relatively small amount of data (e.g., satisfying a threshold data volume) for communication between the UE and the network entity. The UE may receive a low-power synchronization signal via the low-power wake-up radio and may measure a signal strength or quality associated with the low-power synchronization signal. The UE may use this low-power synchronization signal measurement to determine whether to initiate a small data transmission (SDT) session for communicating the data. The UE may transmit an SDT initiation message if the low-power synchronization signal measurement satisfies a threshold value.

### FIELD OF TECHNOLOGY

The following relates to wireless communications, including reference signal measurements using a wake-up radio for small data transmissions (SDTs).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communications systems, a UE may include both a main radio and a low-power wake-up radio. While operating in a radio resource control (RRC) inactive state, the UE may achieve power savings by deactivating the main radio and monitoring for signals using the low-power wake-up radio. However, if the UE or a network entity has data pending for communication between the UE and the network entity, the UE may trigger an RRC connection procedure to reestablish an RRC connection with the network entity in order to communicate the data. The RRC connection procedure may involve significant signaling overhead, processing overhead, and processing latency to transition the UE from the RRC inactive state to an RRC connected state for data communications, even if the amount of data to communicate is relatively small.

### SUMMARY

The systems, methods, and devices of this disclosure each have several innovative aspects, no single one of which is solely responsible for the desirable attributes disclosed herein.

An apparatus is described. The apparatus may include one or more memories storing processor executable code and one or more processors coupled with the one or more memories. The one or more processors may individually or collectively be operable to execute the code to cause the apparatus to receive, via a low power wake-up radio, a low power synchronization signal, transmit a message that indicates initiation of a small data transmission (SDT) session based on a measurement of the low power synchronization signal received via the low power wake-up radio, and communicate an SDT in accordance with the SDT session.

A method for wireless communications is described. The method may include receiving, via a low power wake-up radio, a low power synchronization signal, transmitting a message that indicates initiation of an SDT session based on a measurement of the low power synchronization signal received via the low power wake-up radio, and communicating an SDT in accordance with the SDT session.

Another apparatus for wireless communications is described. The apparatus may include means for receiving, via a low power wake-up radio, a low power synchronization signal, means for transmitting a message that indicates initiation of an SDT session based on a measurement of the low power synchronization signal received via the low power wake-up radio, and means for communicating an SDT in accordance with the SDT session.

A non-transitory computer-readable medium storing code for wireless communications is described. The code may include instructions executable by one or more processors to receive, via a low power wake-up radio, a low power synchronization signal, transmit a message that indicates initiation of an SDT session based on a measurement of the low power synchronization signal received via the low power wake-up radio, and communicate an SDT in accordance with the SDT session.

Some examples of the method, apparatuses, and non-transitory computer-readable medium described herein may further include operations, features, means, or instructions for initiating the SDT session based on the measurement of the low power synchronization signal satisfying a measurement threshold associated with the low power wake-up radio. In some examples of the method, apparatuses, and non-transitory computer-readable medium described herein, the measurement includes an RSRP measurement of the low power synchronization signal.

In some examples of the method, apparatuses, and non-transitory computer-readable medium described herein, the measurement threshold associated with the low power wake-up radio may be based on a second measurement threshold associated with a main radio and an offset value associated with the low power wake-up radio. In some other examples of the method, apparatuses, and non-transitory computer-readable medium described herein, the measurement threshold associated with the low power wake-up radio may be a threshold value configured for the measurement of the low power synchronization signal.

Some examples of the method, apparatuses, and non-transitory computer-readable medium described herein may further include operations, features, means, or instructions for transmitting a user equipment (UE) capability message indicating support for the initiation of the SDT session based on the measurement of the low power synchronization signal, where the message may be transmitted based on the UE capability message.

Some examples of the method, apparatuses, and non-transitory computer-readable medium described herein may further include operations, features, means, or instructions for receiving a configuration message that indicates a relationship between the low power synchronization signal and a pathloss reference signal (PL-RS), a synchronization signal block (SSB), or both based on a transmission configuration indicator (TCI) state for the low power synchronization signal, a quasi-colocation (QCL) relationship indication for the low power synchronization signal, or both, where the measurement of the low power synchronization signal may be based on the relationship between the low power synchronization signal and the PL-RS, the SSB, or both. In some examples of the method, apparatuses, and non-transitory computer-readable medium described herein, the PL-RS, the SSB, or both may be associated with a downlink beam and the low power synchronization signal may be received via the downlink beam based on the relationship between the low power synchronization signal and the PL-RS, the SSB, or both. In some examples of the method, apparatuses, and non-transitory computer-readable medium described herein, the low power synchronization signal may be QCLed with the PL-RS, the SSB, or both in accordance with a QCL type based on the configuration message.

Some examples of the method, apparatuses, and non-transitory computer-readable medium described herein may further include operations, features, means, or instructions for receiving, via the low power wake-up radio, a low power wake-up signal (WUS) including an indication to initiate a mobile-terminated (MT) SDT session, where the message may be transmitted further based on the low power WUS including the indication.

In some examples of the method, apparatuses, and non-transitory computer-readable medium described herein, the message further indicates a request to use the low power wake-up radio for the SDT session, and the SDT may be communicated further based on the request.

Some examples of the method, apparatuses, and non-transitory computer-readable medium described herein may further include operations, features, means, or instructions for waking up a main radio in accordance with the SDT session, where the message may be transmitted and the SDT may be communicated via the main radio.

In some examples of the method, apparatuses, and non-transitory computer-readable medium described herein, the message may be a radio resource control (RRC) resume request message including an information bit indicating the initiation of the SDT session.

In some examples of the method, apparatuses, and non-transitory computer-readable medium described herein, the low power synchronization signal may be received in accordance with a periodicity for a set of multiple low power synchronization signals. Some examples of the method, apparatuses, and non-transitory computer-readable medium described herein may further include operations, features, means, or instructions for performing time resource synchronization, frequency resource synchronization, or both for the low power wake-up radio based on the low power synchronization signal.

Some examples of the method, apparatuses, and non-transitory computer-readable medium described herein may further include operations, features, means, or instructions for operating in accordance with an RRC inactive state, where the SDT session may be based on maintaining the RRC inactive state.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIGS. 1 and 2 show examples of wireless communications systems that support reference signal measurements using a wake-up radio for small data transmissions (SDTs) in accordance with one or more aspects of the present disclosure.

FIGS. 3A and 3B show examples of signaling timelines that support reference signal measurements using a wake-up radio for SDTs in accordance with one or more aspects of the present disclosure.

FIG. 4 shows an example of a process flow that supports reference signal measurements using a wake-up radio for SDTs in accordance with one or more aspects of the present disclosure.

FIGS. 5 and 6 show block diagrams of devices that support reference signal measurements using a wake-up radio for SDTs in accordance with one or more aspects of the present disclosure.

FIG. 7 shows a block diagram of a communications manager that supports reference signal measurements using a wake-up radio for SDTs in accordance with one or more aspects of the present disclosure.

FIG. 8 shows a diagram of a system including a device that supports reference signal measurements using a wake-up radio for SDTs in accordance with one or more aspects of the present disclosure.

FIGS. 9 through 11 show flowcharts illustrating methods that support reference signal measurements using a wake-up radio for SDTs in accordance with one or more aspects of the present disclosure.

### DETAILED DESCRIPTION

In some wireless communications systems, a user equipment (UE) may include multiple radios supporting different operations. For example, the UE may include a main radio for communicating (e.g., transmitting, receiving) control signaling, data signaling, or other information with a wireless network via a network entity. Additionally, the UE may include a wake-up radio, such as a low-power wake-up radio. The UE may operate the low-power wake-up radio using a significantly lower power overhead than used for the main radio. The low-power wake-up radio may support reception of relatively simple signals, such as low-power wake-up signals (WUSs). While operating according to a “sleep mode,” the UE may deactivate the main radio and monitor for WUSs using the low-power wake-up radio to achieve power savings and improve battery life at the UE. In some implementations, the UE may enter the sleep mode while operating in a radio resource control (RRC) inactive state. While in the RRC inactive state, the UE or a network entity may determine a relatively small quantity of data for communication between the UE and the network entity. However, transitioning from the RRC inactive state to an RRC connected state to communicate the relatively small quantity of data may be inefficient, involving significant latency, signaling overhead, and processing overhead at the UE to enter the RRC connected state and communicate the data.

A wireless communications system may support a small data transmission (SDT) procedure to efficiently communicate the relatively small quantity of data via an SDT. An SDT may be an example of a transmission of data that satisfies a threshold data size (e.g., is less than or equal to a configured data volume threshold) and is transmitted to or from a UE that is operating in an RRC inactive state. An SDT session may be a time duration during which the UE maintains the RRC inactive state and communicates one or more SDTs. Communicating SDTs in the RRC inactive state, rather than transitioning to an RRC connected state for data communication, may improve the latency, signaling overhead, and processing overhead associated with the UE communicating the relatively small quantity of data with the network entity.

Additionally, the wireless communications system may enable the UE to achieve further power savings by using the low-power wake-up radio to perform reference signal measurements for the SDT session. For example, to initiate the SDT session, the UE may determine whether a downlink reference signal received from a network entity satisfies a signal strength or signal quality threshold (e.g., a reference signal received power (RSRP) threshold). Rather than activating the main radio to measure an RSRP value using a synchronization signal block (SSB) or pathloss reference signal (PL-RS), the UE may use the low-power wake-up radio to measure the RSRP value using a low-power synchronization signal. The low-power synchronization signal may be an example of any reference signal that may be received and processed by the low-power wake-up radio and that supports synchronization at the UE, such as time synchronization, frequency synchronization, or both with the wireless network. The UE may determine that the SDT session is supported if the measured RSRP value for the low-power synchronization signal satisfies (e.g., is greater than) an RSRP threshold for SDT. Using the low-power wake-up radio to measure the RSRP value may effectively enable the UE to reduce a quantity of times that the UE wakes up the main radio to perform reference signal measurements. Accordingly, using low-power synchronization signals to support SDT session initiation may further improve power savings at the UE.

Aspects of the disclosure are initially described in the context of wireless communications systems. Additional aspects of the disclosure are described with reference to signaling timelines and process flows. Aspects of the disclosure are further illustrated by and described with reference to apparatus diagrams, system diagrams, and flowcharts that relate to reference signal measurements using a wake-up radio for SDTs.

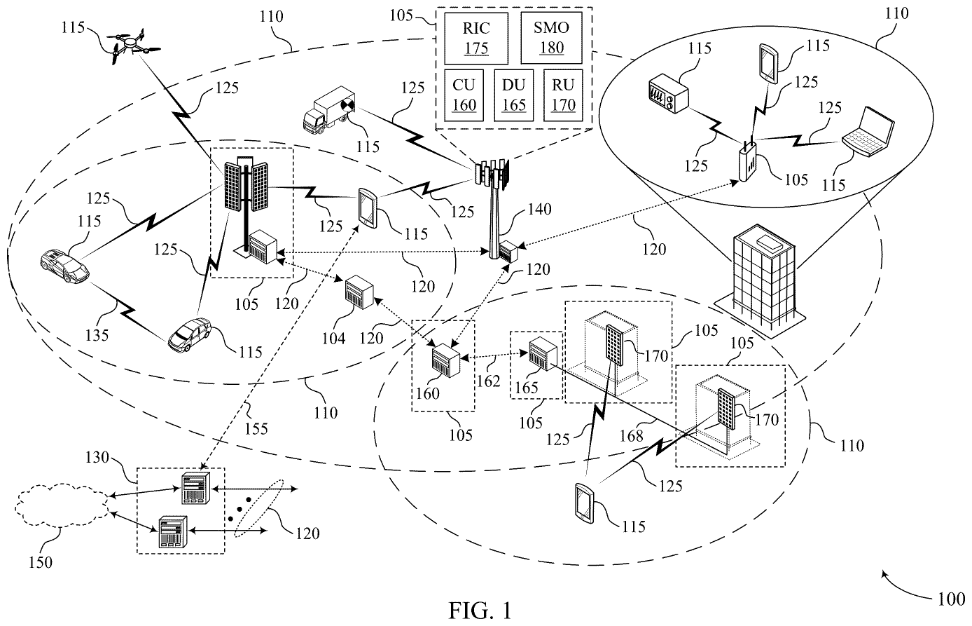

FIG. 1 shows an example of a wireless communications system 100 that supports reference signal measurements using a wake-up radio for SDTs in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3 ), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1 ) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support reference signal measurements using a wake-up radio for SDTs as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(βfₘₐₓ·N_{f}) seconds, for which βfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In some wireless communications systems 100, a UE 115 may include at least two types of radios for communications: a main radio and a low-power radio, which may additionally, or alternatively, be referred to as a low-power wake-up radio or an ultra-low power wake-up radio. The main radio may include—or be an example of—a wireless transceiver circuit configured to transmit and receive data, among other signaling, for the UE 115. The low-power wake-up radio may be an example of a simple radio receiver circuit designed to receive signals (e.g., relatively simple, low-power signals) using a relatively low energy consumption (e.g., a significantly lower energy overhead than the main radio). The UE 115 may conserve power by entering a “sleep mode,” in which the UE 115 sets the main radio to an ultra-low power state (ULPS) (e.g., refraining from communicating via the main radio) and instead monitors for and receives signals via the low-power wake-up radio. If the UE 115 detects a low-power WUS via the low-power wake-up radio, the UE 115 may enter an “active mode” (e.g., wake-up the UE 115 and the main radio) by activating the main radio for communications. The UE 115 may save significant processing power and may extend battery life by increasing an amount of time spent operating in accordance with the sleep mode rather than the active mode.

A UE 115 may additionally operate according to an RRC state. In some examples, the UE 115 may support three RRC states: an RRC idle state (e.g., RRC_IDLE), an RRC connected state (e.g., RRC_CONNECTED), and an RRC inactive state (e.g., RRC_INACTIVE). If the UE 115 does not currently have an RRC connection established with a wireless network (e.g., via a network entity 105), the UE 115 may operate in the RRC idle state. To support wireless communications with the wireless network, the UE 115 may establish an RRC connection via a network entity 105 and may enter the RRC connected state. The UE 115 operating in the RRC connected state may support both access stratum (AS) signaling via the network entity 105 using the RRC connection and non-access stratum (NAS) signaling via the core network 130 using a core network connection. The UE 115 may transmit wireless communications to, and receive wireless communications from, the network entity 105 while operating in the RRC connected state. In some wireless communications systems 100 (e.g., with a 5GC or other core network 130), the UE 115 may save power by entering the RRC inactive state. In the RRC inactive state, the UE 115 may suspend the RRC connection with the network entity 105 while maintaining the core network connection with the core network 130. In some examples, the UE 115 may monitor for signaling (e.g., WUSs, low-power synchronization signals) using the low-power wake-up radio while in the RRC inactive state. Additionally, in the RRC inactive state, the UE 115 may store AS context information associated with the suspended RRC connection to support an efficient transition from the RRC inactive state back to the RRC connected state (e.g., by connecting using the stored AS context information for the RRC connection).

The UE 115 may achieve power savings and improve a signaling overhead while operating according to the RRC inactive state as compared to the RRC connected state. For example, in the RRC connected state, the UE 115 and the network entity 105 may transmit reference signals and perform a set of measurements to maintain the RRC connection between the UE 115 and the network entity 105. However, in the RRC inactive state, the UE 115 and the network entity 105 may reduce the quantity and frequency of both reference signal transmissions and corresponding measurements as compared to the RRC connected state, reducing the signaling overhead associated with reference signals and reducing the processing overhead associated with performing measurements. In some examples, a significant portion of the power consumption associated with operating in the RRC inactive state (or, similarly, the RRC idle state) may be based on the UE 115 performing radio resource management (RRM) measurements for cell reselection. For example, if such RRM measurements are performed by the main radio, waking up the main radio relatively frequently to perform these RRM measurements for cell reselection while in the RRC inactive state may involve significant latency and power overhead. Alternatively, if the UE 115 uses the low-power wake-up radio to perform such RRM measurements for cell reselection (e.g., offloading one or more RRM measurements from the main radio to the low-power wake-up radio), the UE 115 may improve the latency and power overhead associated with cell reselection while operating in the RRC inactive state. The UE 115 may set the main radio to the ULPS and may monitor for signaling using the low-power wake-up radio while operating in the RRC inactive state, further improving the processing overhead at the UE 115. Reducing the processing overhead at the UE 115 may improve a battery life of the UE 115.

In some examples, the UE 115 or the network entity 105 may identify a relatively small amount of data to communicate between the UE 115 and the network entity 105 (e.g., via an RRC connection). However, transitioning the UE 115 from an RRC inactive state to an RRC connected state to communicate the relatively small amount of data may involve inefficient resource usage. For example, entering the RRC connected state may involve significant signaling and measurements at the UE 115, potentially involving a greater control signaling overhead to enter the RRC connected state than to communicate the relatively small amount of data once operating according to the RRC connected state.

To improve the efficiency of the UE 115, the UE 115 may support an SDT procedure. The SDT procedure may involve the UE 115 communicating a relatively small amount of data or other signaling with the network entity 105 while the UE 115 remains operating according to the RRC inactive state (e.g., without transitioning to the RRC connected state). The UE 115 or the network entity 105 may initiate an SDT session and communicate (e.g., transmit, receive) the relatively small amount of data while the UE 115 operates in the RRC inactive state during the SDT session. In some cases, the UE 115 or network entity 105 may enable the SDT session on a radio bearer-basis. For example, the UE 115 and the network entity 105 may communicate SDTs via a first radio bearer via which a first SDT session is active, while the UE 115, the network entity 105, or both may communicate data or other signaling in accordance with an RRC connected state via a second radio bearer via which a second SDT session is inactive (or is unsupported). In some examples, the UE 115 may initiate a mobile-originated (MO) SDT session. In some other examples, the network entity 105 may initiate a mobile-terminated (MT) SDT session.

The UE 115 may support the SDT session if a reference signal measurement at the UE 115 satisfies a threshold. In some other systems, a UE may wake-up a main radio to perform reference signal monitoring and measurements to determine if the SDT session is currently supported. However, waking up the main radio may increase the processing overhead and the signaling latency at the UE 115. In contrast, the wireless communications system 100 may support the UE 115 using the low-power wake-up radio to monitor for and measure reference signals to determine whether to initiate the SDT session. For example, the UE 115 may receive low-power synchronization signals via the low-power wake-up radio to maintain time synchronization, frequency synchronization, or both with the wireless network while the main radio is asleep (e.g., in the ULPS). The UE 115 may additionally, or alternatively, use the low-power synchronization signals to perform reference signal measurements and determine whether to enable the SDT session. Initiating the SDT session based on low-power wake-up radio measurements, and avoiding an additional step of waking up the main radio to perform reference signal measurements, may improve the latency and processing overhead associated with communicating SDTs. That is, using the low-power wake-up radio and low-power reference signals to determine support for SDTs further improves the power savings at the UE 115 achieved based on the SDT procedure.

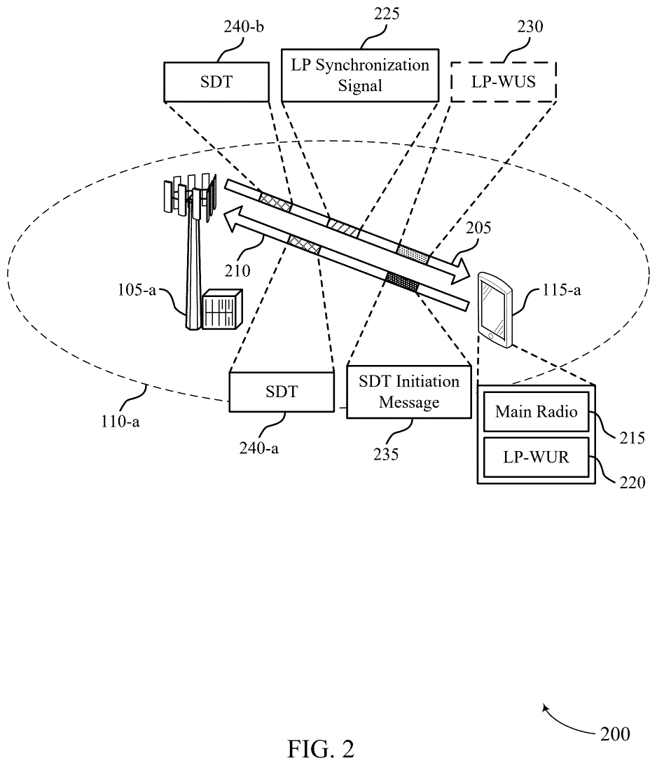

FIG. 2 shows an example of a wireless communications system 200 that supports reference signal measurements using a wake-up radio for SDTs in accordance with one or more aspects of the present disclosure. The wireless communications system 200 may be an example of a wireless communications system 100 as described with reference to FIG. 1. The wireless communications system 200 may include a UE 115-a and a network entity 105-a, which may be examples of a UE 115 and a network entity 105, respectively, as described with reference to FIG. 1. The network entity 105-a may provide network coverage for a wireless network over a coverage area 110-a, which may be an example of a coverage area 110 as described with reference to FIG. 1. The UE 115-a may include a main radio 215 and a low-power wake-up radio 220 for communications. To support efficient SDT sessions, the UE 115-a may use the low-power wake-up radio 220 to receive a low-power synchronization signal 225 and perform a signal strength measurement using the low-power synchronization signal 225 received via the low-power wake-up radio 220.

The UE 115-a and the network entity 105-a may communicate via one or more channels, such as one or more downlink channels 205 and one or more uplink channels 210. In some examples, the UE 115-a may support a “sleep mode” (e.g., in which the UE 115-a deactivates the main radio 215 and monitors for signaling using the low-power wake-up radio 220) and an “active mode” (e.g., in which the UE 115-a activates and communicates using the main radio 215). While operating according to the sleep mode (e.g., in an RRC inactive mode, in an RRC idle mode, during a discontinuous reception (DRX) mode), the UE 115-a may monitor for low-power WUSs 230 via the low-power wake-up radio 220. In some examples, the network entity 105-a may transmit a low-power WUS 230 as a paging early indicator (PEI) to indicate an upcoming paging message from the network entity 105-a to the UE 115-a. If the UE 115-a detects the low-power WUS 230, the UE 115-a may activate the main radio 215 to monitor for an SSB that supports synchronization and to monitor for the paging message via a paging opportunity (PO). In some other examples, the network entity 105-a may transmit the low-power WUS 230 to wake up the UE 115-a for other communications. If the UE 115-a fails to detect a low-power WUS 230, the UE 115-a may maintain the main radio 215 in a deep sleep or ULPS mode for power savings and may continue to monitor for low-power WUSs 230 using the low-power wake-up radio 220.

Additionally, or alternatively, while operating according to the sleep mode (e.g., in an RRC inactive mode, in an RRC idle mode, during a DRX mode), the UE 115-a may monitor for low-power synchronization signals 225. The network entity 105-a may periodically—or according to some schedule—transmit the low-power synchronization signals 225 to the UE 115-a for reception via the low-power wake-up radio 220. A low-power synchronization signal 225 may be transmitted via a specific time resource and a specific frequency resource. The UE 115-a receiving the low-power synchronization signal 225 via the low-power wake-up radio 220 may perform time synchronization, frequency synchronization, or both with the wireless network based on the UE 115-a identifying the specific time and frequency resources used for the transmission of the low-power synchronization signal 225.

In some implementations, the network entity 105-a may configure the UE 115-a with a low-power synchronization signal configuration. For example, the network entity 105-a may transmit an RRC message or other configuration message indicating information relating to the low-power synchronization signals 225. The configuration message may indicate a time resource for transmission of the low-power synchronization signals 225, a frequency resource for the transmission of the low-power synchronization signals 225, a periodicity for the transmission of the low-power synchronization signals 225, a transmission power for the transmission of the low-power synchronization signals 225, or any combination thereof.

Additionally, or alternatively, the configuration message may indicate a one-to-one relationship (e.g., a quasi-colocation (QCL) relationship) between a low-power synchronization signal 225 and an SSB, a PL-RS, or both. For example, the network entity 105-a may transmit the low-power synchronization signal 225 at a same time as—or at a configured time offset from—a corresponding SSB, PL-RS, or both. Additionally, or alternatively, the network entity 105-a may transmit the low-power synchronization signal 225 at a same frequency as—or at a configured frequency offset from—the corresponding SSB, PL-RS, or both. In some examples, the configuration message for a low-power synchronization signal 225 may include transmission configuration indicator (TCI) state information that indicates a PL-RS identifier (ID) value corresponding to the PL-RS that relates to the low-power synchronization signal 225. Additionally, or alternatively, the configuration message for the low-power synchronization signal 225 may include QCL relationship information that indicates a QCL relationship between the low-power synchronization signal 225 and an SSB. In some examples, the QCL relationship information may indicate values X and Y, where the low-power synchronization signal 225 transmitted via resource X is QCLed with the SSB with an SSB index Y, or where the low-power synchronization signal 225 with a low-power synchronization signal ID X is QCLed with the SSB with an SSB index Y. Additionally, or alternatively, the QCL relationship information may indicate a QCL type (e.g., typeA, typeB, typeC, or typeD). The low-power synchronization signal 225 may share one or more signal or channel properties with the SSB according to the QCL type. For example, the low-power synchronization signal 225 and the corresponding SSB may share a Doppler shift, a Doppler spread, an average delay, and a delay spread for QCL typeA; a Doppler shift and a Doppler spread for QCL typeB; an average delay and a Doppler shift for QCL typeC; a spatial reception parameter for QCL typeD; or other similar signal or channel properties for other supported QCL types.

Based on the configured relationship between a low-power synchronization signal 225 and a corresponding SSB, PL-RS, or both, the UE 115-a may correlate measurements performed using the low-power synchronization signal 225 with corresponding measurements for the SSB, the PL-RS, or both. For example, the UE 115-a may measure a signal strength or signal quality of the low-power synchronization signal 225 received via the low-power wake-up radio 220. According to the configured relationship, the UE 115-a may estimate a corresponding signal strength or signal quality measurement for a corresponding SSB, PL-RS, or both without actually receiving the corresponding SSB, PL-RS, or both. The UE 115-a may effectively perform reference signal measurements using the low-power wake-up radio 220, rather than using the main radio 215, to achieve power savings at the UE 115-a.

The wireless communications system 200 may additionally support SDT procedures. In some examples, the UE 115-a may support communicating a relatively small amount of data during an SDT session while the UE 115-a operates in an RRC inactive state. The amount of data that can be communicated via an SDT may be defined by a data volume threshold for SDT. For example, the UE 115-a may transmit an SDT 240-a, receive an SDT 240-b, or both during an SDT session. The SDT session may enable the UE 115-a to conserve processing resources and reduce a signaling overhead associated with transitioning from the RRC inactive state to an RRC connected state for data communications (e.g., fully-connected data communications).

The UE 115-a and the network entity 105-a may perform SDT via random access (RA) resources (e.g., for RA-SDT), pre-configured radio resources (e.g., using a configured grant (CG) for CG-SDT), or some combination thereof. The wireless network may enable—or otherwise support—MO-SDT, MT-SDT, or both in a cell corresponding to the coverage area 110-a. Additionally, or alternatively, a first set of radio bearers may have SDT enabled, while a second set of radio bearers may have SDT disabled (or otherwise not enabled). The UE 115-a may initiate MO-SDT if the UE 115-a identifies a quantity of uplink data pending for transmission to the network entity 105-a that satisfies (e.g., is less than or equal to) an uplink data volume threshold across the radio bearers with SDT enabled, a downlink reference signal measurement satisfies (e.g., is greater than) a threshold, a valid SDT resource is available, or any combination thereof. Additionally, or alternatively, the network entity 105-a may request MT-SDT if the network entity 105-a identifies a quantity of downlink data pending for transmission to the UE 115-a that satisfies (e.g., is less than or equal to) a downlink data volume threshold across the radio bearers with SDT enabled, and the UE 115-a may initiate the MT-SDT if a downlink reference signal measurement satisfies (e.g., is greater than) a threshold.

The UE 115-a may use the low-power synchronization signals 225 received via the low-power wake-up radio 220 for the downlink reference signal measurement. For example, rather than using a measurement of an SSB or PL-RS to initiate an SDT session, the UE 115-a may use a measurement of the corresponding low-power synchronization signal 225 (e.g., in accordance with the configured one-to-one relationships between low-power synchronization signals 225 and SSBs, PL-RSs, or both). In some examples, the UE 115-a may measure an RSRP value for the low-power synchronization signal 225 using the low-power wake-up radio 220. The UE 115-a may compare this measurement, RSRP_{WUR}, to one or more threshold values to determine whether to initiate the SDT session.

In some implementations, the UE 115-a may support multiple signal strength or signal quality thresholds for initiating different types of SDT sessions. In some examples, the thresholds may be pre-configured or otherwise defined for the UE 115-a. In some other examples, the network entity 105-a may configure the thresholds for the UE 115-a (e.g., via RRC signaling) or the UE 115-a may dynamically or semi-statically select one or more thresholds. The UE 115-a may support a first threshold, sdt-RSRP-Threshold, to determine whether to perform an SDT procedure for MO-SDT; a second threshold, sdt-RSRP-ThresholdMT, to determine whether to perform an SDT procedure for MT-SDT; or both. In some examples, the UE 115-a may compare an RSRP measurement for an SSB or PL-RS against the first threshold or the second threshold to determine whether to initiate an SDT session. Additionally, or alternatively, the UE 115-a may support a third threshold, cg-SDT-RSRP-ThresholdSSB, to determine whether to perform a CG-SDT procedure based on an SSB measurement.

Additionally, or alternatively, to support measurements of low-power synchronization signals 225 by the low-power wake-up radio 220, the UE 115-a may support modifications to these thresholds or additional thresholds. In some examples, the UE 115-a may compare the RSRP_{WUR} measurement for a low-power synchronization signal 225 to a first function of the first threshold, sdt-RSRP-Threshold, to determine whether to perform an SDT procedure for MO-SDT or to a second function of the second threshold, sdt-RSRP-ThresholdMT, to determine whether to perform an SDT procedure for MT-SDT. For example, the first function may be sdt-RSRP-Threshold−RSRP_{WUR-Offset}, where the RSRP_{WUR-Offset} is an offset value configured to support using the RSRP_{WUR} measurements for SDT initiation. The second function may be similar (e.g., with a same or different offset value). Additionally, or alternatively, the UE 115-a may compare the RSRP_{WUR} measurement to a third function (e.g., a similar or different function to the first and second functions) of the third threshold, cg-SDT-RSRP-ThresholdSSB, to determine whether to perform a CG-SDT procedure. In some other examples, the UE 115-a may compare the RSRP_{WUR} measurement for the low-power synchronization signal 225 to one or more thresholds defined or otherwise configured specifically for the RSRP_{WUR} measurements. For example, the UE 115-a may compare the RSRP_{WUR} measurement to a fourth threshold, sdt-RSRP-WUR-Threshold, to determine whether to perform an SDT procedure for MO-SDT; a fifth threshold, sdt-RSRP-WUR-ThresholdMT, to determine whether to perform an SDT procedure for MT-SDT; or both. Additionally, or alternatively, the UE 115-a may support a sixth threshold, cg-SDT-RSRP-WUR-ThresholdSSB, to determine whether to perform a CG-SDT procedure. The UE 115-a may directly compare the RSRP_{WUR} measurement to one or more of the fourth threshold, the fifth threshold, and the sixth threshold.

If the RSRP_{WUR} value satisfies a threshold (e.g., is greater than the threshold value), the UE 115-a may wake up the main radio 215 and transmit an SDT initiation message 235 to the network entity 105-a via the main radio 215 to trigger initiation of an SDT session. The SDT initiation message 235 may be an example of an RRC resume request message with an SDT indication (e.g., a bit or bit field set to a value that indicates SDT initiation). The SDT indication may repurpose the RRC resume request message for SDT initiation rather than initiating a transition to an RRC connected state. In some examples, the network entity 105-a may receive the SDT initiation message 235 and transmit an SDT initiation confirmation message in response. The UE 115-a may operate according to the SDT session and may communicate one or more SDTs with the network entity 105-a. For example, the UE 115-a may transmit an SDT 240-a, receive an SDT 240-b, or both using the main radio 215 during the SDT session. The UE 115-a may maintain the RRC inactive state at the UE 115-a throughout the SDT session, such that the SDTs are communicated without transitioning to an RRC connected state, effectively reducing a signaling and processing overhead associated with communicating the data.

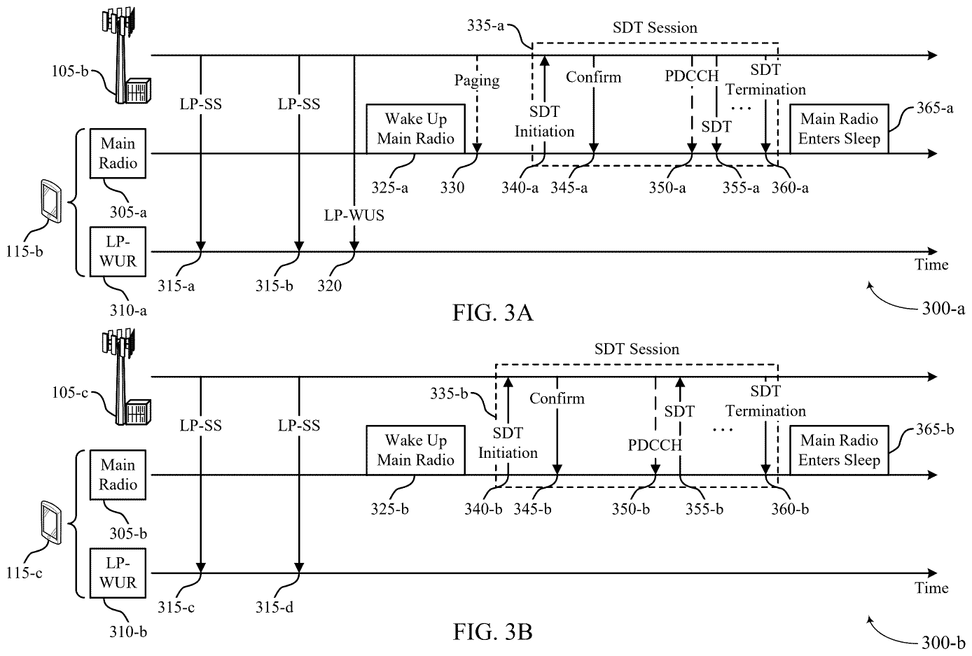

FIGS. 3A and 3B show examples of signaling timelines that support reference signal measurements using a wake-up radio for SDTs in accordance with one or more aspects of the present disclosure. For example, FIG. 3A shows an example of a signaling timeline 300-a that supports an MT-SDT session initiated based on reference signal measurements using a wake-up radio. A UE 115-b and a network entity 105-b, which may be examples of a UE 115 and a network entity 105 as described with reference to FIGS. 1 and 2, may operate according to the signaling timeline 300-a. The UE 115-b may include a main radio 305-a and a low-power wake-up radio 310-a. The UE 115-b may use the low-power wake-up radio 310-a to trigger approval of an SDT session 335-a, which may be an example of an MT-SDT.

The UE 115-b may operate in accordance with an RRC inactive mode. While operating in accordance with the RRC inactive mode, the UE 115-b may monitor for and receive signals using the low-power wake-up radio 310-a. In some examples, the network entity 105-b may periodically (or aperiodically) transmit low-power synchronization signals to the UE 115-b. The UE 115-b may receive the low-power synchronization signals via the low-power wake-up radio 310-a and may perform time synchronization, frequency synchronization, or both using the low-power synchronization signals. For example, the UE 115-b may receive a first low-power synchronization signal 315-a and a second low-power synchronization signal 315-b via the low-power wake-up radio 310-a.

For MT-SDT, the wireless network may trigger initiation of an SDT session 335-a. For example, the network entity 105-b may use a paging message 330 to indicate a request to start the SDT session 335-a. The network entity 105-b may trigger the initiation of the SDT session 335-a based on the network entity 105-b storing a relatively small amount of data (e.g., satisfying a data volume threshold for MT-SDT, sdt-DataVolumeThresholdMT) for transmission to the UE 115-b in a buffer or based on detecting that the UE 115-b has a relatively small amount of data (e.g., satisfying the data volume threshold for MT-SDT) ready for transmission to the network entity 105-b.

In some examples, the network entity 105-b may transmit a low-power WUS 320 to the UE 115-b, and the UE 115-b may receive the low-power WUS 320 via the low-power wake-up radio 310-a. In some implementations, the low-power WUS 320 may include, or be an example of, a PEI for the RRC inactive state at the UE 115-b. If the UE 115-b receives the PEI, the UE 115-b may wake up the main radio 305-a to receive a corresponding paging message 330 (e.g., the paging message 330 indicated by the PEI) via a PO. The paging message 330 may include an indicator notifying the UE 115-b to initiate an SDT session 335-a. For example, the network entity 105-b may set a cause or type of the paging message 330 to indicate “SDT,” “SDT initiation,” or “SDT request.”

Alternatively, in some other implementations, the low-power WUS 320 may itself indicate the UE 115-b to initiate the SDT session 335-a. For example, the low-power WUS 320 may include a bit or bit field that indicates “SDT,” “SDT initiation,” or “SDT request” to the UE 115-b. Accordingly, the UE 115-b may receive the low-power WUS 320 via the low-power wake-up radio 310-a and may determine whether to initiate the SDT session 335-a based on the low-power WUS 320. The UE 115-b may further improve power savings and a processing overhead by using the low-power WUS 320 as the SDT initiation request, as opposed to using the low-power WUS 320 to wake up and monitor for a paging message 330 that operates as the SDT initiation request.

The UE 115-b may perform a wake-up procedure 325-a, for example, in response to receiving the low-power WUS 320. The wake-up procedure 325-a may involve the UE 115-b activating the main radio 305-a. In some examples, the UE 115-b may correspondingly deactivate the low-power wake-up radio 310-a. In some other examples, the UE 115-b may maintain the low-power wake-up radio 310-a in an active state throughout.

The UE 115-b may determine whether the SDT session 335-a is supported based on a set of conditions. For example, the UE 115-b operating in accordance with the RRC inactive state may initiate an RRC resume procedure for SDT if the set of conditions are satisfied. The set of conditions may include: upper layers request resumption of an RRC connection; a system information block (SIB), such as SIB1, includes an sdt-ConfigCommon indication; sdt-Config is configured for the UE 115-b; the pending data (e.g., uplink data, downlink data, or both) is mapped to radio bearers configured for SDT; lower layers indicate that other conditions for initiating SDT are satisfied; or any combination thereof. Additionally, or alternatively, for a reduced capability (RedCap) UE, if a RedCap-specific initial downlink BWP does not include cell-defining (CD)-SSB, the set of conditions may include ncd-SSB-RedCapInitialBWP-SDT being configured for the RedCap UE.

In some examples, one or more of the other conditions for initiating SDT may be RRC configured. For example, the network entity 105-b, or another network entity 105, may transmit an RRC message to the UE 115-b configuring one or more thresholds for initiating SDT. Alternatively, the UE 115-b may store—or be otherwise pre-configured with—the one or more thresholds for initiating SDT. The thresholds may include one or more of the thresholds described with reference to FIG. 2. For example, the UE 115-b may be configured with sdt-RSRP-Threshold, sdt-RSRP-ThresholdMT, cg-SDT-RSRP-ThresholdSSB, one or more functions of these thresholds, sdt-RSRP-WUR-Threshold, sdt-RSRP-WUR-ThresholdMT, cg-SDT-RSRP-WUR-ThresholdSSB, or any combination thereof. Additionally, or alternatively, the UE 115-b may be configured with a data volume threshold (e.g., sdt-DataVolumeThreshold) to determine whether an amount of data pending for transmission via SDT-enabled radio bearers at the UE 115-b supports initiating an MO-SDT procedure. In some examples, the UE 115-b may be configured with a first time threshold (e.g., cg-MT-SDT-MaxDurationToNextCG-Occasion) to determine whether to perform CG-SDT for the MT-SDT, a second time threshold (e.g., cg-SDT-MaxDurationToNextCG-Occasion) to determine whether to perform CG-SDT for MO-SDT, or both. Additionally, or alternatively, the UE 115-b may be configured with a prohibit timer (e.g., sdt-BeamFailureRecoveryProhibitTimer) that protects the UE 115-b from frequent triggering of a random access channel (RACH) procedure based on beam failure recovery during an RA-SDT procedure or during an MT-SDT procedure initiated via a RACH procedure.

The MAC layer at the UE 115-b may indicate to upper layers that the conditions for initiating an SDT procedure are satisfied based on one or more of the thresholds. The UE 115-b may use one or more measurements of low-power synchronization signals to support verifying that the conditions are satisfied. For example, the UE 115-b may measure an RSRP value, RSRP_{WUR}, for the first low-power synchronization signal 315-a, the second low-power synchronization signal 315-b, or both. For MT-SDT, if the measured RSRP_{WUR} satisfies an RSRP threshold (e.g., is greater than sdt-RSRP-WUR-ThresholdMT or a function of sdt-RSRP-ThresholdMT) and if one or more other conditions are met, the MAC layer may indicate to upper layers that the conditions for initiating MT-SDT are satisfied.

In some examples, if the conditions for initiating MT-SDT are not satisfied, the UE 115-b may refrain from waking up the main radio 305-a. If the conditions for initiating MT-SDT are satisfied, the UE 115-b may transmit an SDT initiation message 340-a to start the SDT session 335-a (e.g., an MT-SDT session) via the main radio 305-a. In some implementations, the UE 115-b may transmit the SDT initiation message 340-a in response to the paging message 330 received via the main radio 305-a. In some other implementations, the UE 115-b may transmit the SDT initiation message 340-a in response to the low-power WUS 320 received via the low-power wake-up radio 310-a. The SDT initiation message 340-a may be an example of an RRC resume request with an SDT indication. In some examples, the UE 115-b may transmit the SDT initiation message 340-a via RACH resources configured via system information. For example, the UE 115-b may transmit the SDT initiation message 340-a as an example or component of a RACH Message 1(Msg 1 ) or Message A (MsgA) transmission to initiate RA-SDT (e.g., if one or more thresholds associated with RA-SDT are satisfied). In some other examples, the UE 115-b may transmit the SDT initiation message 340-a via Type 1 CG resources configured via dedicated signaling in an RRC release message to initiate CG-SDT (e.g., if one or more thresholds associated with CG-SDT are satisfied).

The network entity 105-b may receive the SDT initiation message 340-a and may respond with an SDT initiation confirmation message 345-a to initiate the SDT session 335-a. For RA-SDT, the SDT initiation confirmation message 345-a may be an example or component of a RACH Message 2 (Msg2) or Message B (MsgB) transmission. For CG-SDT, the SDT initiation confirmation message 345-a may be an example or component of a physical downlink control channel (PDCCH) message, such as a downlink control information (DCI) message scrambled with, or otherwise based on, a cell radio network temporary identifier (C-RNTI).

During the SDT session 335-a for MT-SDT, the network entity 105-b may transmit one or more SDTs 355-a to the UE 115-b. The UE 115-b may receive the one or more SDTs 355-a via the main radio 305-a while continuing to operate in an RRC inactive mode. In some implementations, the UE 115-b may receive the one or more SDTs 355-a as low-power WUSs via the low-power wake-up radio 310-a. In some examples, the UE 115-b may additionally transmit one or more SDTs to the network entity 105-b during the SDT session 335-a. In some implementations, the network entity 105-b may transmit PDCCH signaling 350-a to indicate one or more SDTs (e.g., resources for additional downlink SDTs after an initial SDT).

In some examples, the network entity 105-b may transmit an RRC release message 360-a to terminate the SDT session 335-a. In some implementations, the wireless network may configure a threshold length for the SDT session 335-a defined by an SDT failure detection timer. The UE 115-b, the network entity 105-b, or both may start the SDT failure detection timer at initiation of the SDT session 335-a and may trigger terminating the SDT session 335-a if the SDT failure detection timer expires. The SDT procedure performed during the SDT session 335-a may be successfully completed if the UE 115-b is directed to a specific RRC state based on an RRC message received from the network entity 105-b. For example, the SDT procedure may be successful if the UE 115-b receives the RRC release message 360-a indicating for the UE 115-b to enter an RRC idle state, the RRC release message 360-a or an RRC reject message indicating for the UE 115-b to continue operation in the RRC inactive state, or an RRC resume message or RRC setup message indicating for the UE 115-b to enter an RRC connected state. Based on successful completion of the SDT procedure, the UE 115-b may remain in the RRC inactive state or may transition to the RRC idle state. The SDT procedure performed during the SDT session 335-a may be unsuccessfully completed if the UE 115-b performs cell reselection, if the SDT failure detection timer expires, if a MAC entity reaches a configured threshold physical RACH (PRACH) preamble transmission threshold, if an RLC entity reaches a configured retransmission threshold, if an integrity check fails during the SDT procedure, if an SDT-specific timing alignment timer or a configuredGrantTimer expires during the SDT procedure via CG resources and the UE 115-b has not received a response from the network entity 105-b after an initial physical uplink shared channel (PUSCH) transmission, or any combination thereof. Based on unsuccessful completion of the SDT procedure, the UE 115-b may transition to the RRC connected state to communicate the data via data transmissions (e.g., full data transmissions, rather than SDTs).

After the SDT session 335-a is terminated, the UE 115-b may perform a sleep procedure 365-a to deactivate the main radio 305-a and monitor for signals using the low-power wake-up radio 310-a.

FIG. 3B shows an example of a signaling timeline 300-b that supports an MO-SDT session initiated based on reference signal measurements using a wake-up radio. A UE 115-c and a network entity 105-c, which may be examples of a UE 115 and a network entity 105 as described with reference to FIGS. 1, 2, and 3A, may operate according to the signaling timeline 300-b. The UE 115-c may include a main radio 305-b and a low-power wake-up radio 310-b. The UE 115-c may use the low-power wake-up radio 310-b to trigger approval of an SDT session 335-b, which may be an example of an MO-SDT.

The UE 115-c may operate in accordance with an RRC inactive state. While operating in accordance with the RRC inactive state, the UE 115-b may receive a first low-power synchronization signal 315-c and a second low-power synchronization signal 315-d via the low-power wake-up radio 310-b. The UE 115-c may determine that a relatively small quantity of data is pending in a buffer for transmission to the network entity 105-c. For example, the amount of data may satisfy a data volume threshold for MO-SDT, sdt-DataVolumeThreshold. The UE 115-c may also measure one or more of the low-power synchronization signals to determine an RSRP_{WUR} value corresponding to a downlink pathloss between the network entity 105-c and the UE 115-c. If the RSRP_{WUR} value satisfies an RSRP threshold (e.g., is greater than sdt-RSRP-WUR-Threshold or a function of sdt-RSRP-Threshold) and the amount of data satisfies the data volume threshold (e.g., is less than or equal to sdt-DataVolumeThreshold), the UE 115-c may trigger initiation of an SDT session 335-b based on the low-power wake-up radio 310-b (e.g., without using measurement by the main radio 305-b).

The UE 115-c may perform a wake-up procedure 325-b, for example, based on triggering initiation of the SDT session 335-b. The wake-up procedure 325-b may involve the UE 115-c activating the main radio 305-b. If the conditions for MO-SDT are satisfied, the UE 115-c may transmit, via the main radio 305-b, an SDT initiation message 340-b (e.g., an RRC resume request message with an SDT indication) to start the SDT session 335-b (e.g., an MO-SDT session). The network entity 105-c may receive the SDT initiation message 340-b and may respond with an SDT initiation confirmation message 345-b (e.g., a RACH Msg2 or MsgB for RA-SDT or a DCI message with C-RNTI for CG-SDT).

During the SDT session 335-b for MO-SDT, the UE 115-c may transmit one or more SDTs 355-b to the network entity 105-c. The UE 115-c may transmit the one or more SDTs 355-b via the main radio 305-b while continuing to operate in the RRC inactive state. In some examples, the UE 115-c may additionally receive one or more SDTs from the network entity 105-c during the SDT session 335-b. In some implementations, the network entity 105-c may transmit PDCCH signaling 350-b to grant uplink resources for one or more SDTs (e.g., resources for additional uplink SDTs after an initial SDT).

In some examples, the network entity 105-c may transmit an RRC release message 360-b to terminate the SDT session 335-b. After the SDT session 335-b is terminated, the UE 115-c may perform a sleep procedure 365-b to deactivate the main radio 305-b and monitor for signals using the low-power wake-up radio 310-b.

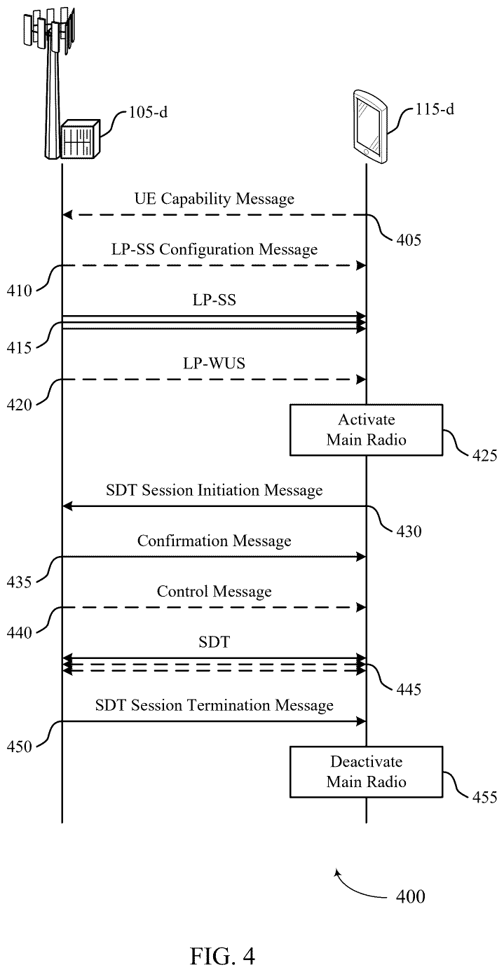

FIG. 4 shows an example of a process flow 400 that supports reference signal measurements using a wake-up radio for SDTs in accordance with one or more aspects of the present disclosure. The process flow 400 may be performed by aspects of the wireless communications system 100 or the wireless communications system 200, as described with reference to FIGS. 1 and 2. For example, a UE 115-d and a network entity 105-d, which may be respective examples of a UE 115 and a network entity 105 described herein, may perform aspects of the process flow 400. In the following description of the process flow 400, operations performed by the UE 115-d and the network entity 105-d may be performed in a different order than is shown. Some operations may be omitted from the process flow 400, and other operations may be added to the process flow 400. Further, although some operations or signaling may be shown to occur at different times for discussion purposes, these operations may occur at the same time. Additionally, or alternatively, other wireless devices may perform aspects of the process flow 400.

In some examples, the UE 115-d may transmit a UE capability message 405 to the network entity 105-d. The UE capability message 405 may indicate that the UE 115-d supports low-power wake-up radio-based RSRP measurements for SDT procedures, for example, based on the UE's low-power wake-up radio supporting reference signal measurements.

In some examples, the UE 115-d may receive, from the network entity 105-d, a low-power synchronization signal configuration message 410. The low-power synchronization signal configuration message 410 may be an example of an RRC message or another configuration message that indicates, to the UE 115-d, a relationship between a low-power synchronization signal and a PL-RS, an SSB, or both. In some implementations, the configuration message may indicate the relationship (e.g., a one-to-one relationship) based on a TCI-state for the low-power synchronization signal, a QCL relationship indication for the low-power synchronization signal, or both. For example, the UE 115-d may receive the low-power synchronization signal via a same downlink beam as the UE 115-d would receive the PL-RS, the SSB, or both. Additionally, or alternatively, the configuration message may indicate a QCL type that defines how the low-power synchronization signal is QCLed with the PL-RS, the SSB, or both.

The UE 115-d may operate in an RRC inactive state and a sleep mode. The UE 115-d may deactivate a main radio and may monitor for signaling using the low-power wake-up radio. The UE 115-d may receive, via the low-power wake-up radio, one or more low-power synchronization signals 415 from the network entity 105-d. For example, the UE 115-d may receive the low-power synchronization signals 415 in accordance with a periodicity of the low-power synchronization signals 415. The UE 115-d may perform time resource synchronization, frequency resource synchronization, or both for the low-power wake-up radio based on the low-power synchronization signals 415. Additionally, or alternatively, the UE 115-d may measure a signal strength or quality based on one or more of the low-power synchronization signals 415 received via the low-power wake-up radio. For example, a measurement of a low-power synchronization signal 415 may be an RSRP measurement, a reference signal received quality (RSRQ) measurement, a signal-to-noise ratio (SNR) measurement, a signal-to-interference-plus noise ratio (SINR) measurement, a received signal strength indicator (RSSI) measurement, or any other signal measurement.

In some examples, the UE 115-d may receive, via the low-power wake-up radio, a low-power WUS 420 from the network entity 105-d. In some examples, the low-power WUS 420 may include an indication to initiate an MT-SDT session. In some other examples, the UE 115-d may determine to initiate an MO-SDT session based on an amount of data pending for transmission at the UE 115-d. Additionally, or alternatively, the network entity 105-d may use a low-power WUS 420 during an SDT procedure to indicate to the UE 115-d to monitor a subsequent PDCCH if a signal strength or signal quality of the downlink channel supports low-power WUS transmissions. For example, a range for successfully receiving low-power WUSs may be relatively smaller than a range for successfully receiving PDCCH transmissions. Accordingly, if the UE 115-d is outside the range for successfully receiving low-power WUSs, the UE 115-d may refrain from using low-power WUSs during the SDT procedure.

The UE 115-d may determine whether the UE 115-d is outside the range for low-power WUSs based on the measurement of the low-power synchronization signal 415. For example, the UE 115-d may measure downlink pathloss (e.g., downlink RSRP) using the low-power wake-up radio and the low-power synchronization signal 415 and may compare the measured downlink pathloss against a threshold. If the measured downlink pathloss value is less than the threshold, the UE 115-d may determine to not use low-power WUSs during the SDT procedure (e.g., the UE 115-d may determine to use the main radio with DCI signals, PDSCH signals, or both). If the measured downlink pathloss value is greater than or equal to the threshold, the UE 115-d may determine to use low-power WUSs during the SDT procedure (e.g., for downlink SDTs).

The UE 115-d may perform main radio activation 425. For example, the UE 115-d may trigger the main radio activation 425 based on receiving the indication to initiate the MT-SDT session, based on determining to initiate the MO-SDT session, or both. The UE 115-d may ramp up the power of the main radio to support transmission and reception via the main radio. In some examples, the UE 115-d may further determine to perform the main radio activation 425 based on the measurement of the low-power synchronization signal (e.g., an RSRP_{WUR} value).

The UE 115-d may transmit, via the activated main radio, a message 430 that indicates initiation of an SDT session. The UE 115-d may transmit the message 430 (e.g., an RRC resume request message including an information bit that indicates the initiation of the SDT session) based on the measurement of the low-power synchronization signal (e.g., the RSRP_{WUR} value). For example, the UE 115-d may initiate the SDT session based on the measurement of the low-power synchronization signal satisfying a measurement threshold associated with the low-power wake-up radio. The measurement threshold may be a threshold value configured for the measurement of the low-power synchronization signal or may be based on a second measurement threshold associated with the main radio and an offset value associated with the low-power wake-up radio. In some examples, the message 430 may further indicate a request to use the low-power wake-up radio for the SDT session (e.g., using low-power WUSs for the SDTs from the network entity 105-d). For example, the message 430 may indicate to the network entity 105-d that a quality of the downlink channel supports using low-power WUSs during the SDT session (e.g., the RRC resume request message may include a bit or bit field indicating a request for the wireless network to use low-power WUSs for the UE 115-d during the SDT session). The UE 115-d may receive, from the network entity 105-d and in response to the message 430, a confirmation message 435 confirming SDT session initiation.

In some examples, the network entity 105-d may transmit a control message 440 (e.g., a DCI message) indicating resources for one or more SDTs 445 (e.g., SDTs 445 transmitted by the network entity 105-d, SDTs 445 transmitted by the UE 115-d, or both). The UE 115-d may communicate one or more SDTs 445 with the network entity 105-d in accordance with the SDT session. For example, the UE 115-d may maintain an RRC inactive state while communicating the SDTs 445 during the SDT session. In some examples, the UE 115-d may transmit one or more SDTs 445 via the main radio during the SDT session. Additionally, or alternatively, the UE 115-d may receive one or more SDTs 445 from the network entity 105-d via the main radio or via the low-power wake-up radio (e.g., using low-power WUSs to communicate the SDTs).

The network entity 105-d may terminate the SDT session by transmitting an SDT session termination message 450 to the UE 115-d. In some examples, the SDT session termination message 450 may be an example of an RRC release message. In some examples, the UE 115-d may perform main radio deactivation 455 based on terminating the SDT session.

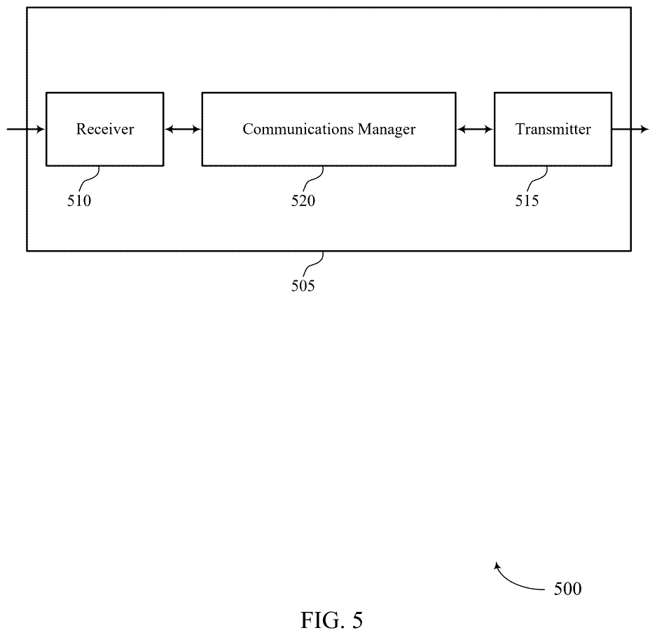

FIG. 5 shows a block diagram 500 of a device 505 that supports reference signal measurements using a wake-up radio for SDTs in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to reference signal measurements using a wake-up radio for SDTs). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to reference signal measurements using a wake-up radio for SDTs). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of reference signal measurements using a wake-up radio for SDTs as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving, via a low power wake-up radio, a low power synchronization signal. The communications manager 520 is capable of, configured to, or operable to support a means for transmitting a message that indicates initiation of an SDT session based on a measurement of the low power synchronization signal received via the low power wake-up radio. The communications manager 520 is capable of, configured to, or operable to support a means for communicating an SDT in accordance with the SDT session.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for reduced processing, reduced power consumption, and improved latency. For example, by using the measurement of the low power synchronization signal to initiate the SDT session, the device 505 may shift measurement processing from a main radio to the low power wake-up radio, improving power savings at the device 505.

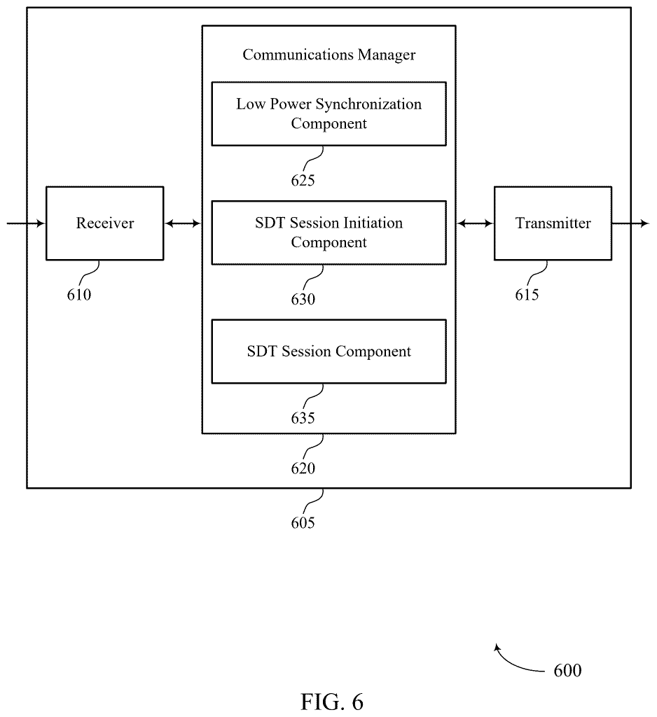

FIG. 6 shows a block diagram 600 of a device 605 that supports reference signal measurements using a wake-up radio for SDTs in accordance with one or more aspects of the present disclosure. The device 605 may be an example of aspects of a device 505 or a UE 115 as described herein. The device 605 may include a receiver 610, a transmitter 615, and a communications manager 620. The device 605, or one of more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to reference signal measurements using a wake-up radio for SDTs). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to reference signal measurements using a wake-up radio for SDTs). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of reference signal measurements using a wake-up radio for SDTs as described herein. For example, the communications manager 620 may include a low power synchronization component 625, an SDT session initiation component 630, an SDT session component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The low power synchronization component 625 is capable of, configured to, or operable to support a means for receiving, via a low power wake-up radio, a low power synchronization signal. The SDT session initiation component 630 is capable of, configured to, or operable to support a means for transmitting a message that indicates initiation of an SDT session based on a measurement of the low power synchronization signal received via the low power wake-up radio. The SDT session component 635 is capable of, configured to, or operable to support a means for communicating an SDT in accordance with the SDT session.

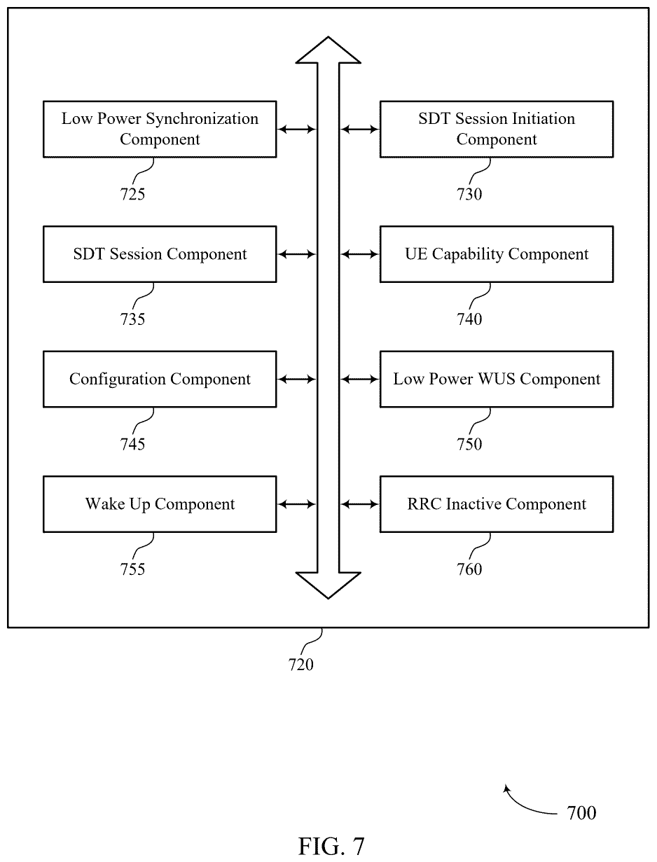

FIG. 7 shows a block diagram 700 of a communications manager 720 that supports reference signal measurements using a wake-up radio for SDTs in accordance with one or more aspects of the present disclosure. The communications manager 720 may be an example of aspects of a communications manager 520, a communications manager 620, or both, as described herein. The communications manager 720, or various components thereof, may be an example of means for performing various aspects of reference signal measurements using a wake-up radio for SDTs as described herein. For example, the communications manager 720 may include a low power synchronization component 725, an SDT session initiation component 730, an SDT session component 735, a UE capability component 740, a configuration component 745, a low power WUS component 750, a wake up component 755, an RRC inactive component 760, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The low power synchronization component 725 is capable of, configured to, or operable to support a means for receiving, via a low power wake-up radio, a low power synchronization signal. The SDT session initiation component 730 is capable of, configured to, or operable to support a means for transmitting a message that indicates initiation of an SDT session based on a measurement of the low power synchronization signal received via the low power wake-up radio. The SDT session component 735 is capable of, configured to, or operable to support a means for communicating an SDT in accordance with the SDT session.

In some examples, the SDT session initiation component 730 is capable of, configured to, or operable to support a means for initiating the SDT session based on the measurement of the low power synchronization signal satisfying a measurement threshold associated with the low power wake-up radio. In some examples, the measurement includes an RSRP measurement of the low power synchronization signal.

In some examples, the measurement threshold associated with the low power wake-up radio is based on a second measurement threshold associated with a main radio and an offset value associated with the low power wake-up radio. In some other examples, the measurement threshold associated with the low power wake-up radio is a threshold value configured for the measurement of the low power synchronization signal.

In some examples, the UE capability component 740 is capable of, configured to, or operable to support a means for transmitting a UE capability message indicating support for the initiation of the SDT session based on the measurement of the low power synchronization signal, where the message is transmitted based on the UE capability message.

In some examples, the configuration component 745 is capable of, configured to, or operable to support a means for receiving a configuration message that indicates a relationship between the low power synchronization signal and a PL-RS, an SSB, or both based on a TCI-state for the low power synchronization signal, a QCL relationship indication for the low power synchronization signal, or both, where the measurement of the low power synchronization signal is based on the relationship between the low power synchronization signal and the PL-RS, the SSB, or both.

In some examples, the PL-RS, the SSB, or both are associated with a downlink beam. In some examples, the low power synchronization signal is received via the downlink beam based on the relationship between the low power synchronization signal and the PL-RS, the SSB, or both. In some examples, the low power synchronization signal is QCLed with the PL-RS, the SSB, or both in accordance with a QCL type based on the configuration message.

In some examples, the low power WUS component 750 is capable of, configured to, or operable to support a means for receiving, via the low power wake-up radio, a low power WUS including an indication to initiate an MT-SDT, where the message is transmitted further based on the low power WUS including the indication.

In some examples, the message further indicates a request to use the low power wake-up radio for the SDT session. In some examples, the SDT is communicated further based on the request.

In some examples, the wake up component 755 is capable of, configured to, or operable to support a means for waking up a main radio in accordance with the SDT session, where the message is transmitted and the SDT is communicated via the main radio.

In some examples, the message is an RRC resume request message including an information bit indicating the initiation of the SDT session.

In some examples, the low power synchronization signal is received in accordance with a periodicity for a set of multiple low power synchronization signals. In some examples, the low power synchronization component 725 is capable of, configured to, or operable to support a means for performing time resource synchronization, frequency resource synchronization, or both for the low power wake-up radio based on the low power synchronization signal.

In some examples, the RRC inactive component 760 is capable of, configured to, or operable to support a means for operating in accordance with an RRC inactive state, where the SDT session is based on maintaining the RRC inactive state.

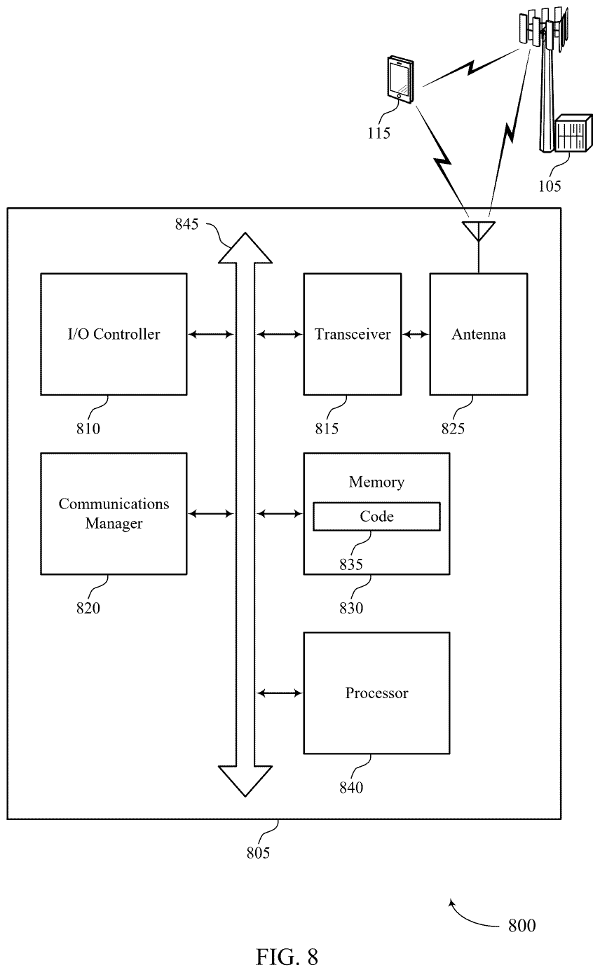

FIG. 8 shows a diagram of a system 800 including a device 805 that supports reference signal measurements using a wake-up radio for SDTs in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting reference signal measurements using a wake-up radio for SDTs). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for receiving, via a low power wake-up radio, a low power synchronization signal. The communications manager 820 is capable of, configured to, or operable to support a means for transmitting a message that indicates initiation of an SDT session based on a measurement of the low power synchronization signal received via the low power wake-up radio. The communications manager 820 is capable of, configured to, or operable to support a means for communicating an SDT in accordance with the SDT session.

By including or configuring the communications manager 820 in accordance with examples as described herein, the device 805 may support techniques for reduced latency, improved user experience related to reduced processing, reduced power consumption, and longer battery life.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of reference signal measurements using a wake-up radio for SDTs as described herein, or the at least one processor 840 and the at least one memory 830 may be otherwise configured to, individually or collectively, perform or support such operations.

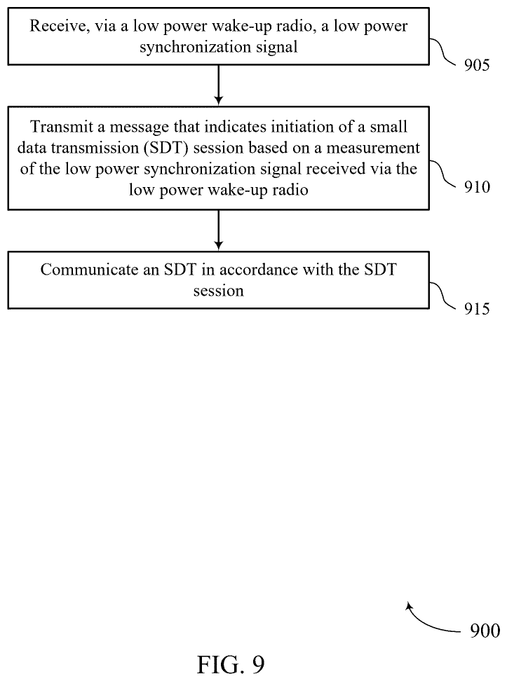

FIG. 9 shows a flowchart illustrating a method 900 that supports reference signal measurements using a wake-up radio for SDTs in accordance with one or more aspects of the present disclosure. The operations of the method 900 may be implemented by a UE or its components as described herein. For example, the operations of the method 900 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At an operation 905, the method may include receiving, via a low power wake-up radio, a low power synchronization signal. The operation 905 may be performed in accordance with examples as disclosed herein. In some examples, aspects of the operation 905 may be performed by a low power synchronization component 725 as described with reference to FIG. 7.

At an operation 910, the method may include transmitting a message that indicates initiation of an SDT session based on a measurement of the low power synchronization signal received via the low power wake-up radio. The operation 910 may be performed in accordance with examples as disclosed herein. In some examples, aspects of the operation 910 may be performed by an SDT session initiation component 730 as described with reference to FIG. 7.

At an operation 915, the method may include communicating an SDT in accordance with the SDT session. The operation 915 may be performed in accordance with examples as disclosed herein. In some examples, aspects of the operation 915 may be performed by an SDT session component 735 as described with reference to FIG. 7.

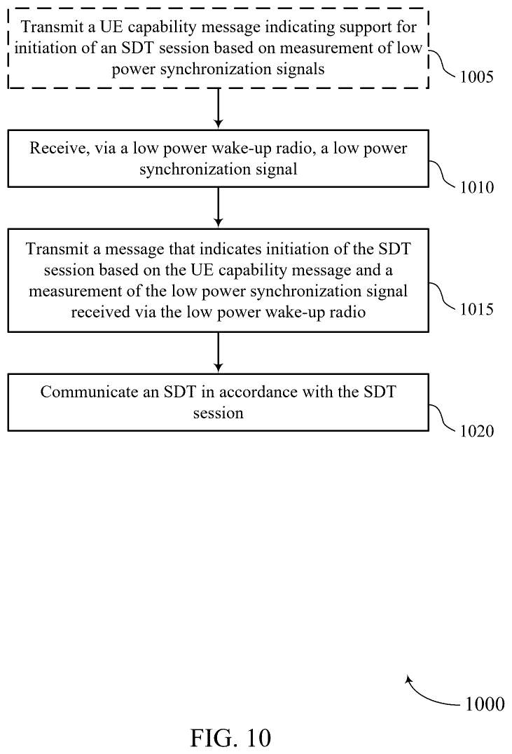

FIG. 10 shows a flowchart illustrating a method 1000 that supports reference signal measurements using a wake-up radio for SDTs in accordance with one or more aspects of the present disclosure. The operations of the method 1000 may be implemented by a UE or its components as described herein. For example, the operations of the method 1000 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At an operation 1005, the method may include transmitting a UE capability message indicating support for initiation of an SDT session based on measurement of low power synchronization signals. The operation 1005 may be performed in accordance with examples as disclosed herein. In some examples, aspects of the operation 1005 may be performed by a UE capability component 740 as described with reference to FIG. 7.

At an operation 1010, the method may include receiving, via a low power wake-up radio, a low power synchronization signal. The operation 1010 may be performed in accordance with examples as disclosed herein. In some examples, aspects of the operation 1010 may be performed by a low power synchronization component 725 as described with reference to FIG. 7.

At an operation 1015, the method may include transmitting a message that indicates initiation of the SDT session based on the UE capability message and a measurement of the low power synchronization signal received via the low power wake-up radio. The operation 1015 may be performed in accordance with examples as disclosed herein. In some examples, aspects of the operation 1015 may be performed by an SDT session initiation component 730 as described with reference to FIG. 7.

At an operation 1020, the method may include communicating an SDT in accordance with the SDT session. The operation 1020 may be performed in accordance with examples as disclosed herein. In some examples, aspects of the operation 1020 may be performed by an SDT session component 735 as described with reference to FIG. 7.

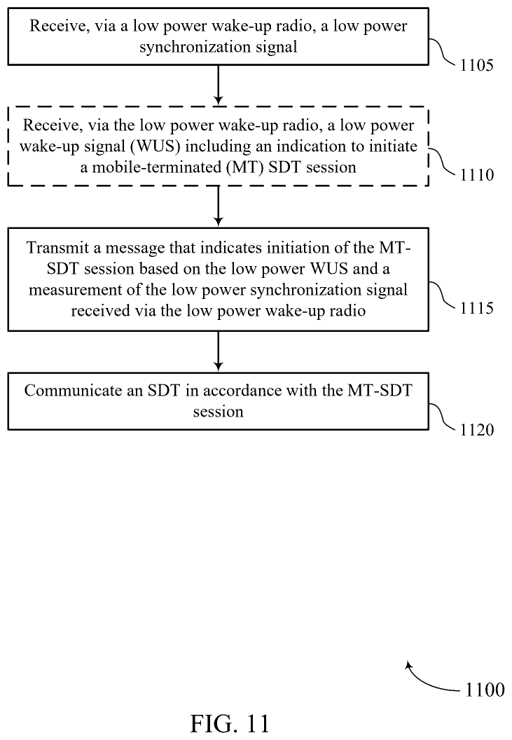

FIG. 11 shows a flowchart illustrating a method 1100 that supports reference signal measurements using a wake-up radio for SDTs in accordance with one or more aspects of the present disclosure. The operations of the method 1100 may be implemented by a UE or its components as described herein. For example, the operations of the method 1100 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At an operation 1105, the method may include receiving, via a low power wake-up radio, a low power synchronization signal. The operation 1105 may be performed in accordance with examples as disclosed herein. In some examples, aspects of the operation 1105 may be performed by a low power synchronization component 725 as described with reference to FIG. 7.

At an operation 1110, the method may include receiving, via the low power wake-up radio, a low power WUS including an indication to initiate an MT-SDT session. The operation 1110 may be performed in accordance with examples as disclosed herein. In some examples, aspects of the operation 1110 may be performed by a low power WUS component 750 as described with reference to FIG. 7.

At an operation 1115, the method may include transmitting a message that indicates initiation of the MT-SDT session based on the low-power WUS and a measurement of the low power synchronization signal received via the low power wake-up radio. The operation 1115 may be performed in accordance with examples as disclosed herein. In some examples, aspects of the operation 1115 may be performed by an SDT session initiation component 730 as described with reference to FIG. 7.

At an operation 1120, the method may include communicating an SDT in accordance with the MT-SDT session. The operation 1120 may be performed in accordance with examples as disclosed herein. In some examples, aspects of the operation 1120 may be performed by an SDT session component 735 as described with reference to FIG. 7.

The following provides an overview of aspects of the present disclosure:

Aspect 1: A method for wireless communications, comprising: receiving, via a low power wake-up radio, a low power synchronization signal; transmitting a message that indicates initiation of an SDT session based at least in part on a measurement of the low power synchronization signal received via the low power wake-up radio; and communicating an SDT in accordance with the SDT session.

Aspect 2: The method of aspect 1, further comprising: initiating the SDT session based at least in part on the measurement of the low power synchronization signal satisfying a measurement threshold associated with the low power wake-up radio.

Aspect 3: The method of aspect 2, wherein the measurement comprises an RSRP measurement of the low power synchronization signal.

Aspect 4: The method of either of aspects 2 or 3, wherein the measurement threshold associated with the low power wake-up radio is based at least in part on a second measurement threshold associated with a main radio and an offset value associated with the low power wake-up radio.

Aspect 5: The method of either of aspects 2 or 3, wherein the measurement threshold associated with the low power wake-up radio is a threshold value configured for the measurement of the low power synchronization signal.

Aspect 6: The method of any of aspects 1 through 5, further comprising: transmitting a UE capability message indicating support for the initiation of the SDT session based at least in part on the measurement of the low power synchronization signal, wherein the message is transmitted based at least in part on the UE capability message.

Aspect 7: The method of any of aspects 1 through 6, further comprising: receiving a configuration message that indicates a relationship between the low power synchronization signal and a PL-RS, an SSB, or both based at least in part on a TCI-state for the low power synchronization signal, a QCL relationship indication for the low power synchronization signal, or both, wherein the measurement of the low power synchronization signal is based at least in part on the relationship between the low power synchronization signal and the PL-RS, the SSB, or both.

Aspect 8: The method of aspect 7, wherein the PL-RS, the SSB, or both are associated with a downlink beam; and the low power synchronization signal is received via the downlink beam based at least in part on the relationship between the low power synchronization signal and the PL-RS, the SSB, or both.

Aspect 9: The method of either of aspects 7 or 8, wherein the low power synchronization signal is QCLed with the PL-RS, the SSB, or both in accordance with a QCL type based at least in part on the configuration message.

Aspect 10: The method of any of aspects 1 through 9, further comprising: receiving, via the low power wake-up radio, a low power WUS comprising an indication to initiate an MT-SDT session, wherein the message is transmitted further based at least in part on the low power WUS comprising the indication.

Aspect 11: The method of any of aspects 1 through 10, wherein: the message further indicates a request to use the low power wake-up radio for the SDT session; and the SDT is communicated further based at least in part on the request.

Aspect 12: The method of any of aspects 1 through 11, further comprising: waking up a main radio in accordance with the SDT session, wherein the message is transmitted and the SDT is communicated via the main radio.

Aspect 13: The method of any of aspects 1 through 12, wherein the message is an RRC resume request message comprising an information bit indicating the initiation of the SDT session.

Aspect 14: The method of any of aspects 1 through 13, wherein the low power synchronization signal is received in accordance with a periodicity for a plurality of low power synchronization signals.

Aspect 15: The method of any of aspects 1 through 14, further comprising: performing time resource synchronization, frequency resource synchronization, or both for the low power wake-up radio based at least in part on the low power synchronization signal.

Aspect 16: The method of any of aspects 1 through 15, further comprising: operating in accordance with an RRC inactive state, wherein the SDT session is based at least in part on maintaining the RRC inactive state.

Aspect 17: An apparatus, comprising: one or more memories storing processor-executable code; and one or more processors coupled with the one or more memories and individually or collectively operable to execute the code to cause the apparatus to perform a method of any of aspects 1 through 16.

Aspect 18: An apparatus for wireless communications, comprising at least one means for performing a method of any of aspects 1 through 16.

Aspect 19: A non-transitory computer-readable medium storing code for wireless communications, the code comprising instructions executable by one or more processors to perform a method of any of aspects 1 through 16.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus, comprising:
one or more memories storing processor-executable code; and
one or more processors coupled with the one or more memories and individually or collectively operable to execute the code to cause the apparatus to:
receive, via a low power wake-up radio, a low power synchronization signal;
transmit a message that indicates initiation of a small data transmission session based at least in part on a measurement of the low power synchronization signal received via the low power wake-up radio; and
communicate a small data transmission in accordance with the small data transmission session.

2. The apparatus of claim 1, wherein the one or more processors are individually or collectively further operable to execute the code to cause the apparatus to:
initiate the small data transmission session based at least in part on a measurement threshold associated with the low power wake-up radio that is satisfied in accordance with the measurement of the low power synchronization signal.

3. The apparatus of claim 2, wherein the measurement comprises a reference signal received power measurement of the low power synchronization signal.

4. The apparatus of claim 2, wherein the measurement threshold associated with the low power wake-up radio is based at least in part on a second measurement threshold associated with a main radio and an offset value associated with the low power wake-up radio.

5. The apparatus of claim 2, wherein the measurement threshold associated with the low power wake-up radio is a threshold value configured for the measurement of the low power synchronization signal.

6. The apparatus of claim 1, wherein the one or more processors are individually or collectively further operable to execute the code to cause the apparatus to:
transmit a user equipment (UE) capability message that indicates support for the initiation of the small data transmission session based at least in part on the measurement of the low power synchronization signal, wherein the message is transmitted based at least in part on the UE capability message.

7. The apparatus of claim 1, wherein the one or more processors are individually or collectively further operable to execute the code to cause the apparatus to:
receive a configuration message that indicates a relationship between the low power synchronization signal and a pathloss reference signal, a synchronization signal block, or both based at least in part on a transmission configuration indicator state for the low power synchronization signal, a quasi-colocation relationship indication for the low power synchronization signal, or both, wherein the measurement of the low power synchronization signal is based at least in part on the relationship between the low power synchronization signal and the pathloss reference signal, the synchronization signal block, or both.

8. The apparatus of claim 7, wherein:
the pathloss reference signal, the synchronization signal block, or both are associated with a downlink beam; and
the low power synchronization signal is received via the downlink beam based at least in part on the relationship between the low power synchronization signal and the pathloss reference signal, the synchronization signal block, or both.

9. The apparatus of claim 7, wherein the low power synchronization signal is quasi-colocated with the pathloss reference signal, the synchronization signal block, or both in accordance with a quasi-colocation type based at least in part on the configuration message.

10. The apparatus of claim 1, wherein the one or more processors are individually or collectively further operable to execute the code to cause the apparatus to:
receive, via the low power wake-up radio, a low power wake-up signal that comprises an indication to initiate a mobile-terminated small data transmission session, wherein the message is transmitted further based at least in part on the low power wake-up signal that comprises the indication.

11. The apparatus of claim 1, wherein:
the message further indicates a request to use the low power wake-up radio for the small data transmission session; and
the small data transmission is communicated further based at least in part on the request.

12. The apparatus of claim 1, wherein the one or more processors are individually or collectively further operable to execute the code to cause the apparatus to:
wake up a main radio in accordance with the small data transmission session, wherein the message is transmitted and the small data transmission is communicated via the main radio.

13. The apparatus of claim 1, wherein the message is a radio resource control resume request message that comprises an information bit that indicates the initiation of the small data transmission session.

14. The apparatus of claim 1, wherein the low power synchronization signal is received in accordance with a periodicity for a plurality of low power synchronization signals.

15. The apparatus of claim 1, wherein the one or more processors are individually or collectively further operable to execute the code to cause the apparatus to:
perform time resource synchronization, frequency resource synchronization, or both for the low power wake-up radio based at least in part on the low power synchronization signal.

16. The apparatus of claim 1, wherein the one or more processors are individually or collectively further operable to execute the code to cause the apparatus to:
operate in accordance with a radio resource control inactive state, wherein the small data transmission session is based at least in part on the operation in accordance with the radio resource control inactive state.

17. A method for wireless communications, comprising:
receiving, via a low power wake-up radio, a low power synchronization signal;
transmitting a message that indicates initiation of a small data transmission session based at least in part on a measurement of the low power synchronization signal received via the low power wake-up radio; and
communicating a small data transmission in accordance with the small data transmission session.

18. The method of claim 17, further comprising:
initiating the small data transmission session based at least in part on the measurement of the low power synchronization signal satisfying a measurement threshold associated with the low power wake-up radio.

19. The method of claim 17, further comprising:
transmitting a user equipment (UE) capability message indicating support for the initiation of the small data transmission session based at least in part on the measurement of the low power synchronization signal, wherein the message is transmitted based at least in part on the UE capability message.

20. A non-transitory computer-readable medium storing code for wireless communications, the code comprising instructions executable by one or more processors to:
receive, via a low power wake-up radio, a low power synchronization signal;
transmit a message that indicates initiation of a small data transmission session based at least in part on a measurement of the low power synchronization signal received via the low power wake-up radio; and
communicate a small data transmission in accordance with the small data transmission session.
